(19) United States
(12) Patent Application Publication
(10) Pub. No.: US 2016/0260027 A1
(43) Pub. Date: Sep. 8, 2016

(54) ROBOT CONTROLLING APPARATUS AND ROBOT CONTROLLING METHOD

(71) Applicant: CANON KABUSHIKI KAISHA, Tokyo (JP)

(72) Inventors: Nobuaki Kuwabara, Yokohama-shi (JP); Masahiro Suzuki, Kawasaki-shi (JP); Kazuhiko Kobayashi, Yokohama-shi (JP); Yusuke Nakazato, Tokyo (JP)

(21) Appl. No.: 15/051,893

(22) Filed: Feb. 24, 2016

(30) Foreign Application Priority Data
Mar. 3, 2015 (JP) 2015-041691

(51) Int. Cl. G06N 99/00; B25J 13/08

(52) U.S. Cl. CPC G06N 99/005; B25J 13/08; Y10S 901/03

(57) ABSTRACT

To enable work safely in a space where a robot and a worker coexist without defining an area in a work space using a monitoring boundary or the like and thus improve productivity, there is provided a robot controlling apparatus which controls the robot by detecting time-series states of the worker and the robot, and comprises: a detecting unit configured to detect a state of the worker; a learning information holding unit configured to hold learning information obtained by learning the time-series states of the robot and the worker; and a controlling unit configured to control an operation of the robot based on the state the worker output from the detecting unit and the learning information output from the learning information holding unit.

### BACKGROUND OF THE INVENTION

1. Field of the Invention

The present invention relates to robot controlling apparatus and method for performing work in a space where a worker and a robot coexist.

2. Description of the Related Art

In recent years, a system of performing work in a space where a worker and a robot coexist attracts attention to improve efficiency of production and assembling. However, when performing the work in the space where the worker and the robot coexist, there is a fear that the worker is harmed because of interference between the worker and the robot. In consideration of such inconvenience, Japanese Patent Application Laid-Open No. 2008-191823 discloses the method of preventing such a dangerous situation by providing two monitoring boundaries to be used to monitor or watch various operations such as object's boundary crossing and the like. In this method, one of the provided monitoring boundaries is set as an invalidation monitoring boundary, and the set invalidation monitoring boundary is made switchable between the two monitoring boundaries. That is, the area between the two monitoring boundaries is the area where each of the worker and the robot can exclusively enter. Thus, in this method, it is possible to cause the worker and the robot to perform the work with improved safety in the space where the worker and the robot coexist.

However, in Japanese Patent Application Laid-Open No. 2008-191823, since only either the worker (person) or the robot can perform the work in the area between the monitoring boundaries, there is a case where productivity deteriorates.

### SUMMARY OF THE INVENTION

To solve such a problem as described above, a robot controlling apparatus of the present invention which controls a robot by detecting time-series states of a worker and the robot, comprises: a detecting unit configured to detect a state of the worker; a learning information holding unit configured to hold learning information obtained by learning the time-series states of the robot and the worker; and a controlling unit configured to control an operation of the robot based on the state of the worker output from the detecting unit and the learning information output from the learning information holding unit.

According to the present invention, it enables work safely in the space where the robot and the worker coexist, without defining an area in the work space using the monitoring boundary or the like. Thus, it is possible to improve productivity.

Further features of the present invention will become apparent from the following description of exemplary embodiments with reference to the attached drawings.

### BRIEF DESCRIPTION OF THE DRAWINGS

FIG. 1 is a diagram illustrating the entire constitution of each of robot controlling apparatuses according to the first, second and fourth embodiments.

FIG. 2 is a diagram for describing each of cases according to the first, second and third embodiments.

FIGS. 3A, 3B and 3C are diagrams for describing the state of a worker detected by a detecting unit.

FIGS. 4A, 4B and 4C are diagrams for describing the state of a robot.

FIGS. 5A, 5B and 5C are diagrams indicating a model for learning the operations of the worker and the robot.

FIG. 6 is a flow chart indicating a procedure of learning the model related to the embodiment.

FIG. 7 is a flow chart indicating a controlling procedure by the robot controlling apparatus according to the first embodiment.

FIG. 8 is a flow chart indicating a controlling procedure by the robot controlling apparatus according to the second embodiment.

FIG. 9 is a diagram illustrating the entire constitution of a robot controlling apparatus according to the third embodiment.

FIG. 10 is a flow chart indicating a controlling procedure by the robot controlling apparatus according to the third embodiment.

FIG. 11 is a diagram for describing a case according to the fourth embodiment.

FIG. 12 is a flow chart indicating a controlling procedure by the robot controlling apparatus according to the fourth embodiment.

FIG. 13 is a diagram for describing a holding method of a time-series state of the worker.

FIG. 14 is a diagram for describing a holding method of a learning result model.

FIGS. 15A and 15B are diagrams illustrating the learning result model.

### DESCRIPTION OF THE EMBODIMENTS

Preferred embodiments of the present invention will now be described in detail in accordance with the accompanying drawings.

### First Embodiment

A robot controlling apparatus according to the present embodiment uses, in a case where a robot and a worker perform work in a space where the robot and the worker coexist, learning information obtained by previously learning time-series states of the robot and the worker in the work, More specifically, it a probability that the time-series states of the worker and the robot currently performing the work are the learned time-series states of the worker and the robot is high, the robot controlling apparatus controls the robot to continue the operation. On the other hand, if the probability that the time-series states of the worker and the robot currently performing the work are the time-series states of the worker and the robot at the time of learning is low, the robot controlling apparatus controls the robot to stop or decelerate the operation. As just described, by controlling the robot with use of the previously learned information, it aims to improve productivity while securing safety even in case of performing the work in the space where the robot and the worker coexist.

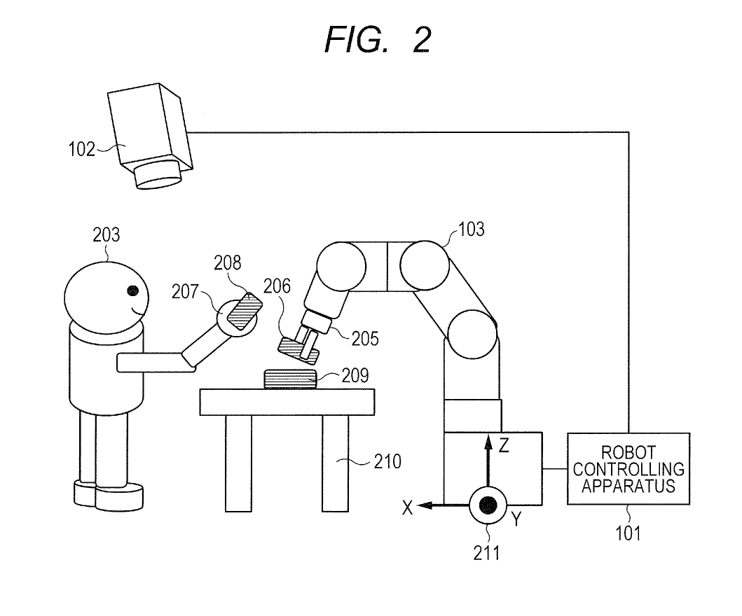

Initially, a case example of work of a worker 203 and a robot 103 to which the robot controlling apparatus according to the present embodiment is applicable will be described with reference to FIG. 2.

In the case example illustrated in FIG. 2, the robot 103 and a sensor 102 are connected to a robot controlling apparatus 101, and a hand 205 is connected to the robot 103. The hand 205 grasps a work target 206. Also, the worker 203 grasps a work target 208 by his/her hand 207, Besides, a robot coordinate system 211 has been defined.

In a next state, the robot 103 fits the grasped work target 206 on a work target 209 set on a work table 210. At the same time, also the worker 203 fits the grasped work target 208 on the work target 209 set on the work table 210.

The robot controlling apparatus 101 evaluates the time-series state of the worker 203 and the time-series state of the robot 103 by using the sensor 102, on the basis of the previously learned information. If the probability that the time-series states of the worker 203 and the robot 103 which are currently performing the work are the learned time-series states of the worker 203 and the robot 103 is high, the robot is controlled to continue the operation. On the other hand, if the probability that the time-series states of the worker 203 and the robot 103 which are currently performing the work are the learned time-series states of the robot and the worker is low, the robot is controlled to stop or decelerate the operation.

By the above control, the robot 103 can fit the grasped work target 206 on the work target 209 arranged on the work table 210. At the same time, also the worker 203 can fit the grasped work target 208 on the work target 209 arranged on the work fable 210.

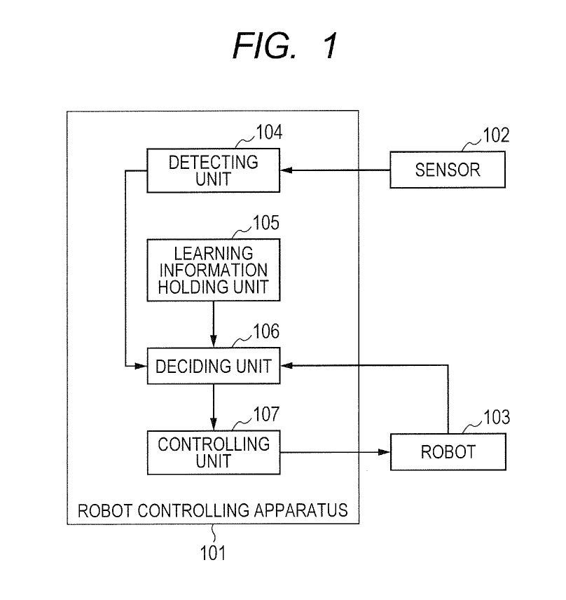

Then, the constitution of the robot controlling apparatus 101 in FIG. 2 will be described with reference to FIG. 1.

FIG. 1 is the block diagram illustrating an example of the constitution of the robot controlling apparatus 101 according to the present embodiment. The sensor 102 which senses the state of the worker 203, and the robot 103 are provided. A detecting unit 104 detects the state of the worker 203 based on the information from the sensor 102. A learning information holding unit 105 holds the learning information obtained by time-serially learning the state of the robot 103 and the state of the worker 203. A deciding unit 106 decides the operation of the robot 103 based on the information respectively input from the robot 103, the detecting unit 104 and the learning information holding unit 105. A controlling unit 107 controls the robot 103 based on the information input from the deciding unit 106.

Hereinafter, the respective parts of the robot controlling apparatus 101, the sensor 102 and the robot 103 will be described in detail.

The sensor 102 is the device which senses the state of the worker. It is necessary for the sensor 102 to output the information by which the detecting unit 104 can recognize the state of the worker. Here, it should be noted that the state of the worker is a parameter for expressing a behavior (or an action) of the worker, and the state of the worker in the present embodiment is the position of the hand of the worker viewed from the robot coordinate system 211 defined in FIG. 2.

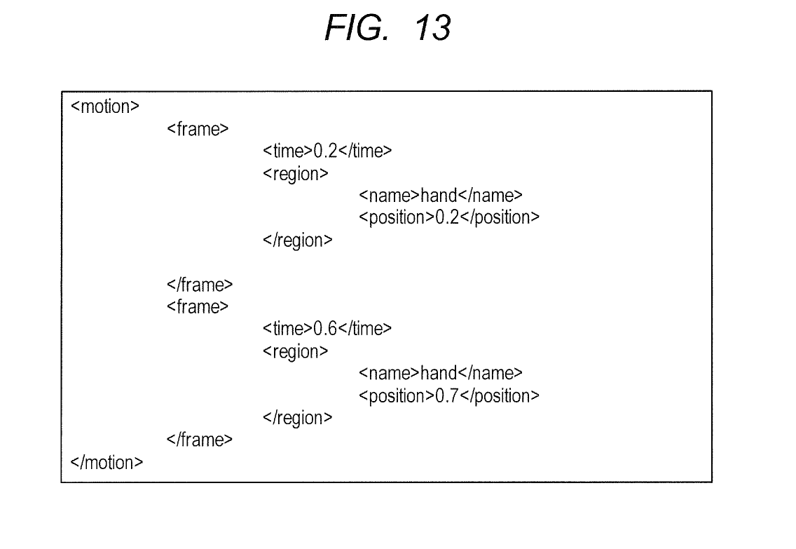

Then, a method of holding the data of the position of the hand of the worker will be described with reference an example illustrated in FIG. 13. The position of the hand of the worker is held by an XML (Extensible Markup Language) form. The behavior for one work is held with data tagged by <motion>, and the one work is discretely and time-serially held. For time-series holding, plural elements tagged by <frame> are held, and the tag <frame> is composed of a tag <time> recording a time from a work start and a tap <region> of the part or the hand of the worker. In the present embodiment, “hand” is designated for a tag <name> because the position of the hand is held. Besides, the value of the position of a specific part of the arm of the worker, i.e., the value of the barycentric position of the hand, is held in the portion tagged by <position>.

The sensor 102 uses a camera which can obtain a three-dimensional range image so as to output the information by which the detecting unit 104 can recognize the state of the worker.

Next, the detecting unit 104 detects the state of the worker from the information input from the sensor 102. Here, various methods of obtaining the position and orientation of the parts of the worker from two-dimensional and three-dimensional images have been proposed. For example, method described in Japanese Patent Application Laid-Open No. 2001-092978 may be used.

The robot 103 may be any kind of robot if it is controllable and is able to output the state thereof.

In the learning information holding unit 105, model information obtained by learning changes of the states of the robot 103 and the sensor 102 have been previously recorded.

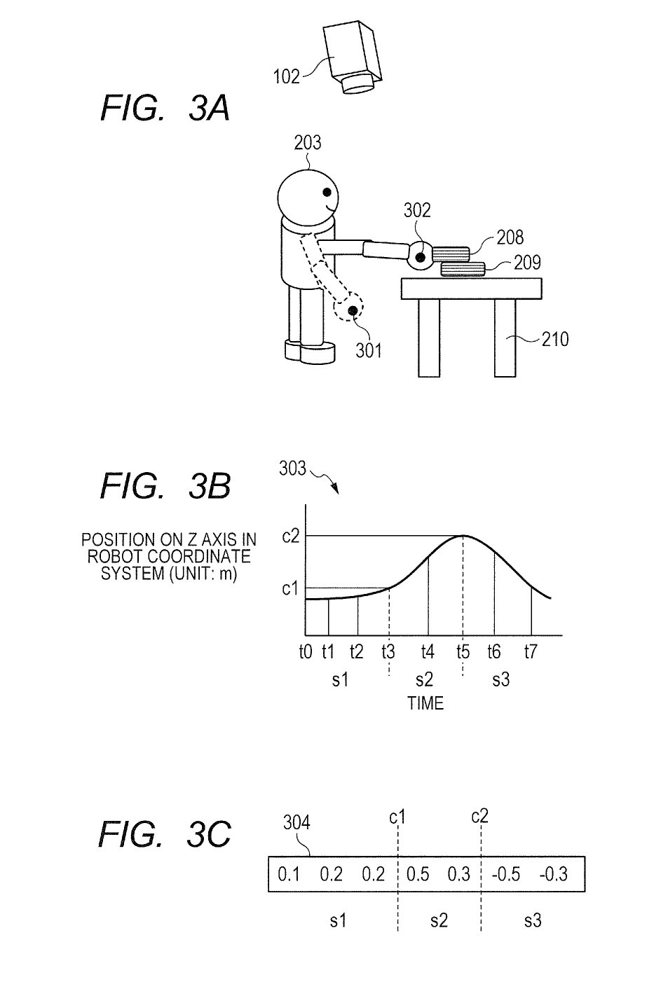

Then, a method of generating the model information recorded in the learning information holding unit 105 will be described with reference to FIGS. 3A to 3C, 4A to 4C, 5A to 5C, 6, 14, 15A and 15B.

The model information recorded in the learning information holding unit 105 is the model information generated from the operations by which the worker and the robot perform the working. The model information is composed of the structure of the model and parameters.

As the structure of the model, a hidden Markov model suitable for a signal pattern with a possibility of expansion and contraction is used.

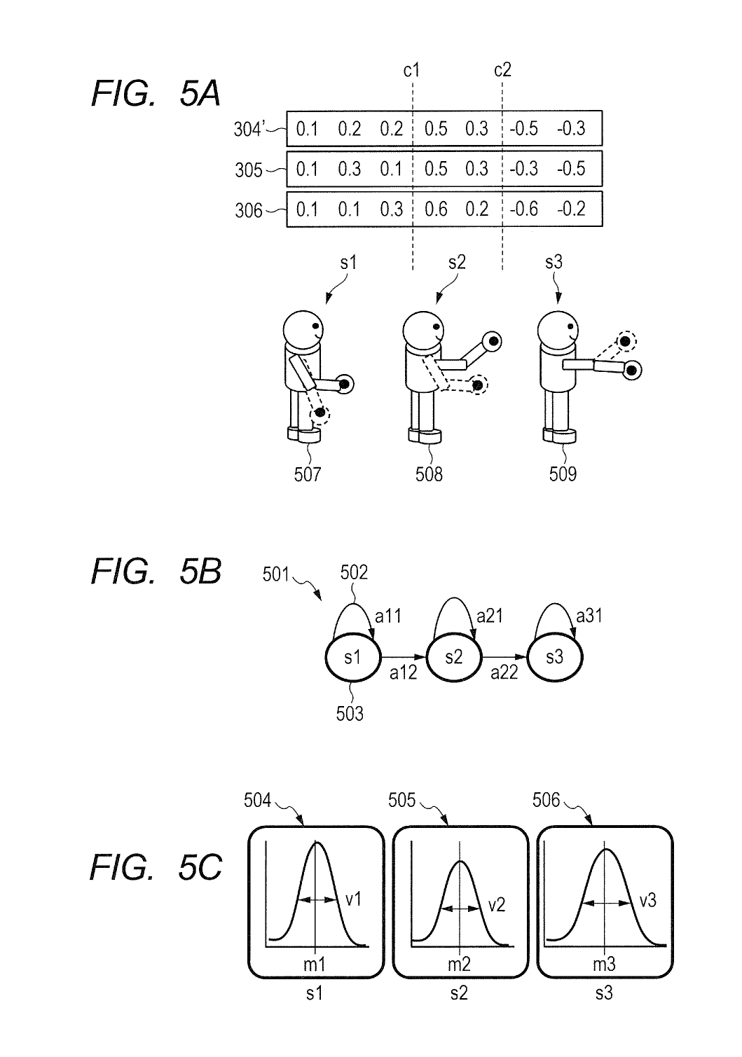

More specifically, the model, such as a model 501 of FIG. 5B composed of a state 503 and a state transition 502 is used.

States s1, s2 and 53 are probability density functions, and the respective states are the normal-distribution probability density functions as indicated by 504, 505 and 506 of FIG. 5C.

Next, a method of learning the model will be described. That is, the model is learned from operation samples obtained by the several-time operations for the work by the worker and the robot. In the present embodiment, it is assumed that the state of the worker to be learned is the position of the hand of the worker and the state of the robot to be learned is the position of the hand of the robot.

The learning of the model is to obtain the transition probability of each state shown in FIG. 5B, the parameters of a11, a12, a21, a22 and a31, the parameters of the normal-distribution probability density functions of the respective states shown in FIG. 5C, averages m1, m2 and m3, and dispersions v1, v2 and v3.

Here, the time-series state of the operation of the worker for the learning is obtained for the information of a position 302 of the hand of the worker 203 by the sensor 102, as shown in FIG. 3A.

Incidentally, FIG. 3A illustrates the operation of moving the position of the hand of the worker 203 from position 301 to the position 302.

The position of the hand of the worker 203 shown in FIG. 3A can be written as indicated by a graph 303 of FIG. 3B indicating the relation between time and the position of the hand.

The graph 303 of the position of the hand shown in FIG. 3B will be described in detail.

In the graph 303, the horizontal axis corresponds to time, and the vertical axis corresponds to the Z-direction position of the robot coordinate system 211 shown in FIG. 2.

Although the position of the hand of the worker 203 can be expressed three-dimensionally, only the Z-axis coordinates are used here for simplifying the description.

In case of expanding the description three-dimensionally, the model 501 as shown in FIG. 5B may be provided not only for the Z axis but also for the X and Y axes.

The position of the band at a point t0 shown in FIG. 3B has been previously set as an initial position for starting the work. In addition, check points such as hand. positions c1 and c2 of FIG. 3B have been defined for measuring the position of the hand. In FIG. 3B, c1 is set to 0.5 m, and c2 is set to 1.3 m. By the check points of c1 and c2, temporal changes of the position of the hand are divided into groups.

In FIG. 3B, it is assumed that the position from the initial position to c1 is s1, the position from c1 to c2 is s2, and the position from c2 to the final position is s3. By the above grouping, it is possible to obtain result learned for each tendency of the value of the hand position input for each group. Thus, it is possible to have an effect that the learning result in which the feature operation has more reflected, as compared with a case where the temporal changes are not grouped. This is the reason why the temporal changes are grouped.

The time when the position 302 of the hand of the worker 203 reaches c1 is assumed to be t3, and the time from t0 is equally divided by t1 and t2. Likewise, the time when the position of the hand reaches c2 is assumed to be t5, and the time from t3 is equally divided by t4. Here, even if the time reaches c1 is changed, the same learning model can be used. This is the reason why the time is equally divided.

In addition, it may be possible to obtain the operation by including, into the state of the worker 203, not only the position of the hand of the worker shown in FIG. 3A but also the state of the work target 208 grasped by the worker 203. By including the state of the work target 208, it is possible to have an effect capable of coping with falling off of a part and failure of grasp of the target.

Next, to obtain the information indicating the feature of the operation to be learned, the position of the hand at each of t1, t2, t3, t4, t5, t6 and t7 in FIG. 3B is extracted as the information of the position of the hand. Then, a difference between the values of the positions at the previous and next points is set as the feature of the operation of the worker to be learned. For example, the difference between the position of the hand at the point t1 and the position of the hand at the point t0 is 0.1, and the difference between the position of the hand at the point t2 and the position of the hand at the point t1 is 0.2. Likewise, if the difference between the values of the positions at the previous and next points is obtained and the obtained differences are arranged from the left, a numeric string 304 as shown in FIG. 3C is obtained.

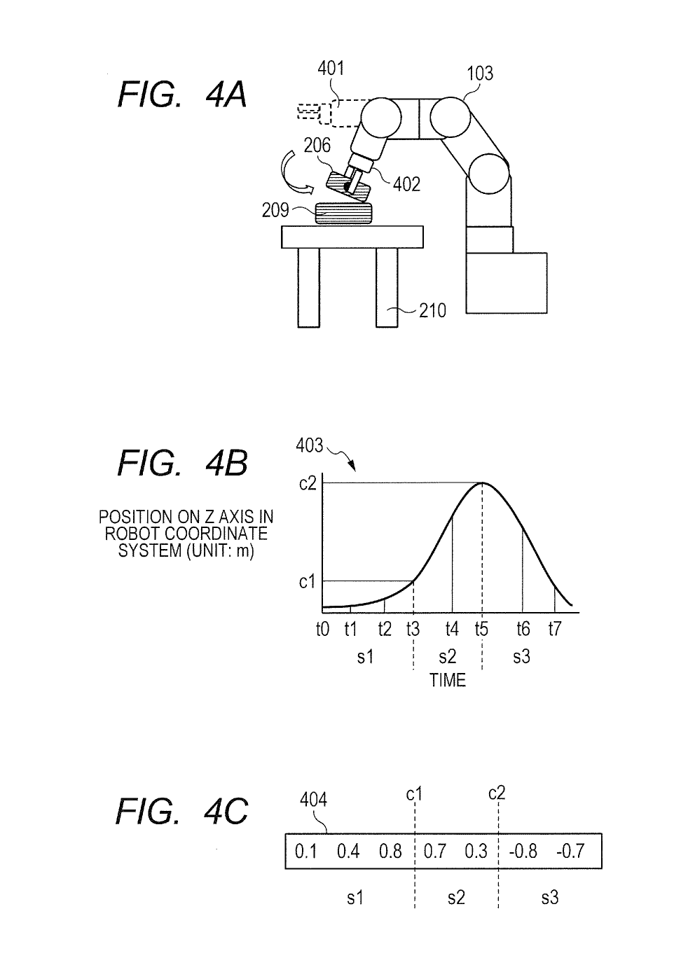

In the method of obtaining the time-series state of the operation of the robot 103 for the learning, angle information of the joint of the robot 103 is obtained by reading the information of an encoder built in the joint of the robot 103, as shown in FIG. 4A. If the angle of the joint of the robot 103 can be known, the position of the hand of the robot 103 can be known by a calculation of forward kinematics.

Incidentally, FIG. 4A illustrates the operation of moving the position of the hand of the robot 103 from a position 401 to a position 402.

The position of the joint of the robot 103 shown in FIG. 4A can be written as indicated by a graph 403 of FIG. 4B indicating the relation between time and the position of the joint.

The embodiment shown in FIGS. 4A to 4C pays attention to the operation of one joint. Of course, the number of joints from which the states are obtained is not limited to one. Namely, it may be possible to use plural joints, if they correspond to the parts representative of the operation of the robot 103 for the work. In addition, it may be possible to obtain the operation by including the state of the work target 206 grasped by the robot 103 of FIG. 4A into the state of the robot 103. By including the state of the work target 206, it is possible to have an effect capable of coping with falling oft of a part and failure of grasp of the target.

To obtain the information indicating the feature of the operation to be learned, the position of the and at each of t0, t1, t2, t3, t4, t5, t6 and t7 in FIG. 4B is extracted as the information of the position of the hand, and a difference of the values is set as the feature of the operation of the robot to be learned. As a result, if the difference between the values of the positions of the hand at the previous and next points is obtained and the obtained differences are arranged from the left, a numeric string 404 as shown in FIG. 4C is obtained.

Subsequently, a method of obtaining the parameters of the model of the worker from the information of the time-series states of the plural workers obtained in the procedure described with reference to FIGS. 3A to 3C will be described with reference to FIGS. 5A to 5C. Here, since a method of obtaining the parameters of the model of the robot is substantially the same, the description of this method is omitted.

As shown in FIG. 5A, the grouped operations of plural operation samples 304′, 305 and 306 of the worker respectively correspond to 507, 508 and 509. The respective groups are assumed as the states of the model 501, and each state is assumed as s1, s2 and s3.

Next, the average and dispersion of the data of each of sectioned states s1, s2 and s3 are obtained. As a result, if it is assumed that the operation samples 304′, 305 and 306 are all the samples to be used for the learning, then the average of the state s1 is m1=0.17 and the dispersion thereof is v1=0.0075, the average of the state s2 is m2=0.4 and the dispersion thereof is v2=0.024, and the average of the state s3 is m3=−0.4 and the dispersion thereof is v3=0.024. These parameters are represented as the graphs 504, 505 and 506 shown in FIG. 5C.

Next, the state transition probability is obtained from the plural operation samples 304′, 305 and 306 of the worker. In the operation samples 304′, 305 and 306, the state transition from s1 is performed nine times, and the state transition from s1 to s1 is performed six. times. Thus, the transition probability of all is 6/9. Likewise, the transition probability of a12 is 3/9, the transition probability of a21 is 3/6, the transition probability of a22 is 3/6, and the transition probability of a31 is 1.

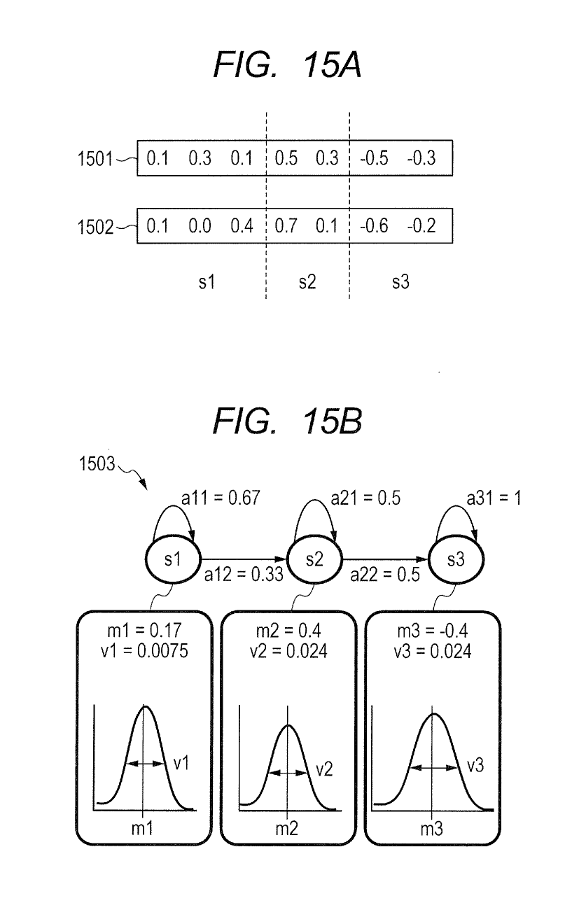

The obtained results of the parameters are as shown by 1503 of FIG. 15B.

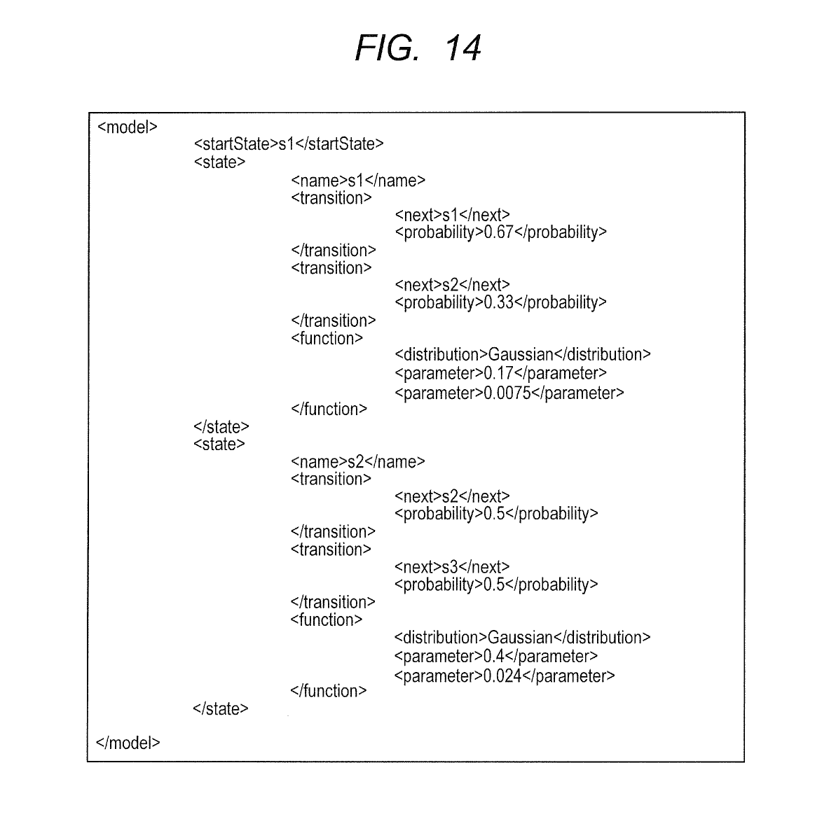

In addition, a method of holding the parameters of the model will be described with reference to FIG. 14. The parameter of the motel is held by the XML form

The one model is held with data tagged by <model>, and the name of the initial state is held with data tagged by <startState>. The one model holds (has) the plural states.

The one state is held with data tagged by <state>, and the name of the state is held with data tagged by <name>. The information of the state transition is held by the area tagged by <transition>. The state name of the state transition destination is held with data tagged by <next>, and the state transition probability is held with data tagged <probability>. The probability density function of state is held with data tagged by <function>, and the function name is held with data tagged by <distribution>. Further, the parameter of the function is held with data tagged by <parameter>.

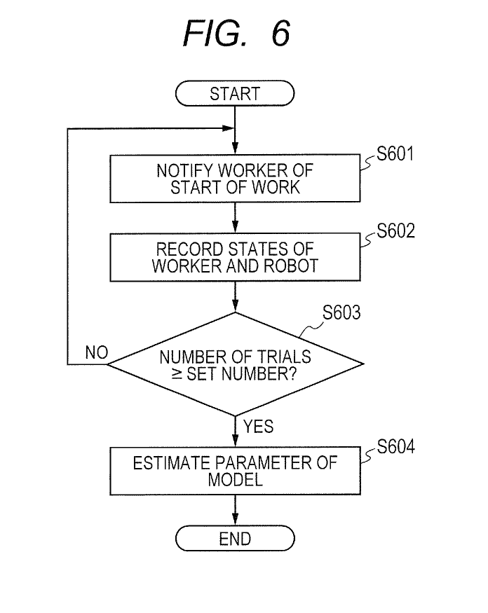

Then, the procedure for obtaining the learned model 1503 of FIG. 15B will be described with reference to the flow chart illustrated in FIG. 6.

In S601, a start of the work for the target to be learned is notified to the worker 203. After the notification, the robot 103 starts the operation, and also the worker 203 starts the operation.

In S602, the states of the worker 203 and the robot 103 performing the work for the target t be learned are time-serially recorded.

In S603, it is decided whether or not the number of trials reaches a set repetition number. Here, if the repetition number is larger, accuracy of the learning increases. However, in this case, a time necessary for the learning is prolonged. In any case, if it is decided that the number of trials reaches the set repetition number, the process is advanced to S604 to estimate the parameter of the model, and then the process is ended. On the other hand, if it is decided that the number of trials does not reach the set repetition number, the process is returned to S601.

FIG. 1 will be described again. The deciding unit 106 decides the operation of the robot 103, based on the time-series state of the robot 103 output from the robot 103, the time-series state of the worker 203 output from the detecting unit 104, and the model input from the learning information holding unit 105. More specifically, it is assumed that the model input from the learning information holding unit 105 to the deciding unit 106 is M and the time-series states input from the robot 103 and the detecting unit 104 to the deciding unit 106 are y. At this time, if it is assumed that possible state transition is sᵢ, a probability P(y|M) that the time-series state y is generated from the model M is obtained by the following expression (1).

$$P ( y \vert M ) = {\sum }_{i} P ( y \vert {s}_{i} ) P ( {s}_{i} \vert M ) \qquad ( 1 )$$

The deciding unit 106 compares the probability obtained by the expression (1) with a preset threshold, and performs the decision based on the obtained comparison result. Then, if the probability obtained by the expression (1) is lower than the threshold, a control signal for stopping or decelerating the operation of the robot 103 is output to the controlling unit 107 because there is a fear that the worker 203 is harmed by the operation of the robot. Here, to decelerate the operation of the robot 103 is to decrease the operation speed of the robot to be lower than the set work speed.

On the other hand, if the probability obtained by the expression (1) exceeds the preset threshold, a control signal for continuing the operation of the robot 103 is output to the controlling unit 107. Here, it is assumed that the threshold to be used by the deciding unit 106 is “5”.

The controlling unit 107 comprises a not-illustrated computer system consisting of a CPU (central processing unit), a ROM (read only memory), a RAM (random access memory) and the like. The processes indicated, by the flow charts indicated by FIGS. 6, 7, 8, 10 and 12 are achieved on the premise that the CPU decompresses the programs stored in the ROM to the RAM and then executes the decompressed programs.

Of course, the above threshold is different if the content of the work is different. In any case, a concrete example of the decision of the operation of the worker 203 in the work will be described with reference to FIGS. 15A. and 15B.

it is assumed that time-series states 1501 and 1502 of the operation of the worker 203 are input to the model 1503 of FIG. 15B learned by the sample of FIG. 5A. Here, the state 1501 is the time-series state of the operation of the worker 203 in case of performing the operation close to that at the time of the learning, and the state 1502 is the time-series state of the operation of the worker 203 in case of performing the operation different from that at the time of the learning.

Here, since the calculation method for the robot 103 is the same as that for the worker, the description of the relevant method is omitted.

For the purpose of description, it is assumed that there is only one kind of state transition x indicated by the expression (1). That is, as illustrated in FIG. 15A, the state transition x is transitioned in the order of s1, s1, s1, s2, s2, s3 and s3. When the time-series state 1501 of the operation of the worker 203 is input, since the state is transitioned in the order of s1, s1, s1, s2, s2, s3 and s3, the right side P(x|M) of the expression (1) is given as indicated by the expression (2).

$$\begin{matrix}P ( x \vert M ) = a 11 \times a 11 \times a 12 \times a 21 \times a 22 \times a 31 \\ = 0.67 \times 0.67 \times 0.33 \times 0.5 \times 0.5 \times 1 \\ = 0.03703425\end{matrix} \qquad ( 2 )$$

Subsequently, in the right side P(y|x) of the expression (1), the value of the time-series state 1501 of the operation of the worker 203 is substituted for the probability density function of each of the states s1, s2 and s3. As a result, the expression (3) is given.

$$\begin{matrix}P ( y \vert x ) = s 1 ( 0.1 ) \times s 1 ( 0.3 ) \times s 1 ( 0.1 ) \times s 2 ( 0.5 ) \times s 2 ( 0.3 ) \times \\ s 3 ( - 0.5 ) \times s 3 ( - 0.3 ) \\ = 3.43 \times 1.41 \times 3.43 \times 2.09 \times 2.09 \times 2.09 \times 2.09 \\ = 315.76569\end{matrix} \qquad ( 3 )$$

Therefore, according to the expressions (2) and (3), the left side P(y|M) of the expression (1) is given by the expression (4).

$$\begin{matrix}P ( y \vert M ) = P ( y \vert x ) P ( y \vert M ) \\ = 315.76569 \times 0.03703425 \\ = 11.69415\end{matrix} \qquad ( 4 )$$

Here, the set threshold is “5”, and the value obtained by the expression (4) is equal to or larger than the threshold. Therefore, in the case of the time-series state 1501 of the operation of the worker 203 input to the deciding unit 106, the control signal for continuing the operation of the robot 103 is output to the controlling unit 107.

Next, in the case of the time-series state 1502 of the operation of the worker 203, since the state transition of the right side P(x|M) of the expression (1) is the same, this side is given by the expression (2) as well as the state 1501.

Subsequently, in the right side P(y|x) of the expression (1), the value of the time-series state 1502 of the operation of the worker 203 is substituted for the probability density function of each of the states s1, s2 and s3. As a result, the expression (5) is given.

$$\begin{matrix}P ( y \vert x ) = s 1 ( 0.1 ) \times s 1 ( 0.0 ) \times s 1 ( 0.4 ) \times s 2 ( 0.7 ) \times s 2 ( 0.1 ) \times \\ s 3 ( - 0.6 ) \times s 3 ( - 0.2 ) \\ = 3.43 \times 0.72 \times 0.12 \times 0.39 \times 0.39 \times 1.12 \times 1.12 \\ = 1.656986252\end{matrix} \qquad ( 5 )$$

Therefore, according to the expressions (2) and (5), the left side P(y|M) of the expression (1) is given by the expression (6).

$$\begin{matrix}P ( y \vert M ) = P ( y \vert x ) P ( x \vert M ) \\ = 1.656986252 \times 0.03703425 \\ = 0.061365243\end{matrix} \qquad ( 6 )$$

Here, the set threshold is “5”, and the value obtained by expression (6) is smaller than the threshold. Therefore, in the case of the time-series state 1502 of the operation of the worker input to the deciding unit 106, the control signal for stopping or decelerating the operation of the robot 103 is output to the controlling unit 107 because there is a fear that the worker 203 is harmed by the operation of the robot.

The controlling unit 107 controls the operation of the robot 103 based on the information of the operation of the robot 103 input from the deciding unit 106.

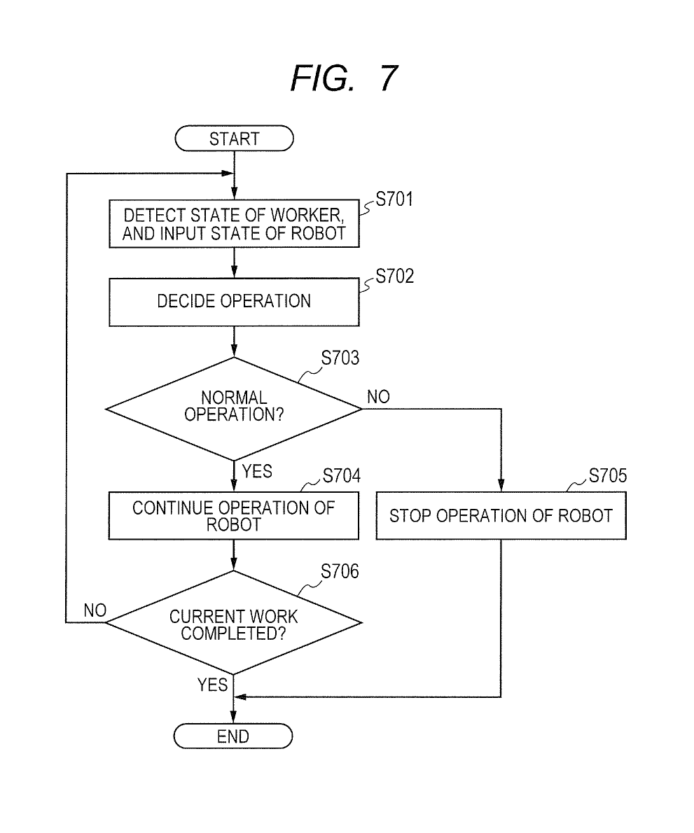

Next, the controlling procedure of the robot controlling apparatus 101 according to the present embodiment will be described with reference to the flow chart illustrated in FIG. 7

In S701, the detecting unit 104 outputs the state of the worker 203 to the deciding unit 106, based on the information input from the sensor 102. Moreover, the detecting unit obtains the information of the state of the robot 103 from the robot 103, and outputs the obtained information to the deciding unit 106.

In S702, the deciding unit 106 inputs the information of the worker 203 from the detecting unit 104, inputs the information of the state of the robot 103 from the robot 103, and inputs the information of the model from the learning information holding unit 105. Then, the deciding unit calculates the probability from the input information, compares the calculated probability with the threshold, and performs the decor based on the calculated result.

If the calculated probability is equal to or higher than the threshold in S703, the process is advanced to S704. On the other hand, if the calculated probability is lower than the threshold in S703, the process is advanced to S705.

If there are the plural pieces of information of the model input from the learning information holding unit 105, for example, if there are the respective models for robot 103 and the worker 203, all the models are evaluated. Then, if the probabilities of all the models are equal to or higher than the threshold in S703, the process is advanced to S704.

On the other hand, if at least one of the probabilities of the models is lower than the threshold in S703, the process is advanced to S705.

In S704, it is decided that the operations of the robot 103 and the worker are normal because the probability calculated by the deciding unit 106 is equal to or higher than the threshold, and the controlling unit 107 controls the operation of the robot 103 so as to continue the operation of the robot 103.

In S705, it is decided that there is the possibility or fear that the worker 203 is harmed because the probability calculated by the deciding unit 106 is equal to or lower than the threshold, and the controlling unit 107 controls the robot 103 so as to stop or decelerate the operation of the robot 103.

In S706, the controlling unit 107 decides whether or not the current work is completed. Then, if the current work is not completed, the process is returned to S701. On the other hand, if the current work is completed, the process is ended.

According to the constitution as described above, in case of performing the work in the space where the worker and the robot coexist, the learning information obtained by previously learning the time-series states of the work of the worker and the robot is used. If the probability that the time-series states of the worker and the robot currently performing the work are the time-series states of the worker and the robot at the time of learning is high, the robot is controlled to continue the work. On the other hand, if the probability that the time-series states of the worker and the robot currently performing the work are the time-series states of the worker and the robot at the time of learning is low, the robot is controlled to stop or decelerate the work. As just described, controlling the robot with use of the learning information obtained by learning the time-series states of the work of the worker and the robot, it is possible to improve productivity while securing safety even in case of performing the work in the space where the worker and the robot coexist.

### Second Embodiment

As well as the first embodiment, the robot controlling apparatus according to the present embodiment uses, in case of performing the work in the space where the robot, and the worker coexist, the learning information obtained by previously learning the time-series states of the work of the robot and the worker. Then, if a probability that the time-series states of the worker and the robot currently performing the work are the time series states of the worker and the robot at the time of learning is high, the robot is controlled to continue the operation (work). On the other hand, if the probability that the time-series states of the worker and the robot currently performing the work are the time-series states of the worker and the robot at the time of learning is low, the robot is controlled to stop or decelerate the operation.

Besides, in the second embodiment, after controlling to stop or decelerate the operation of the robot, return of the work is notified to the worker, and then it is controlled to cause the worker to again start the work. By such control, the robot controlling apparatus improves a rate of operation of the robot, and thus improves productivity while securing safety even in case of performing the work in the space where the worker and the robot coexist.

In the second embodiment, the constitutions other than the deciding unit 106 are the same as those of the robot controlling apparatus described in the first embodiment. Therefore, the deciding unit in the second embodiment will be described with reference to FIG. 1.

The deciding unit 106 decides the operation of the robot 103, based on the time-series state of the robot 103 output from the robot 103, the time-series state of the worker 203 output from the detecting unit 104, and the model input from the learning information holding unit 105.

In case of deciding the operation of the robot 103, the deciding unit 106 compares the probability obtained by the expression (1) described in the first embodiment with a preset threshold, and decides the operation based on the comparison result. That is if the probability obtained by the expression (1) exceeds the threshold, the deciding unit outputs a control signal for continuing the Operation of the robot 103 to the controlling unit 107.

If the probability obtained by the expression (1) is lower than the threshold, a control signal for stopping or decelerating the operation of the robot 103 is output to the controlling unit 107 because there is a fear that the worker 203 is harmed by the operation of the robot. In addition, after stopping or decelerating the robot 103, the deciding unit 106 of the second embodiment notifies the worker 203 of the return of the work. After then, the deciding unit again decides the operation of the robot 103, based on the time-series state of the robot 103 output from the robot 103, the time-series state of the worker output from the detecting unit 104, and the model input from the learning information holding unit 105.

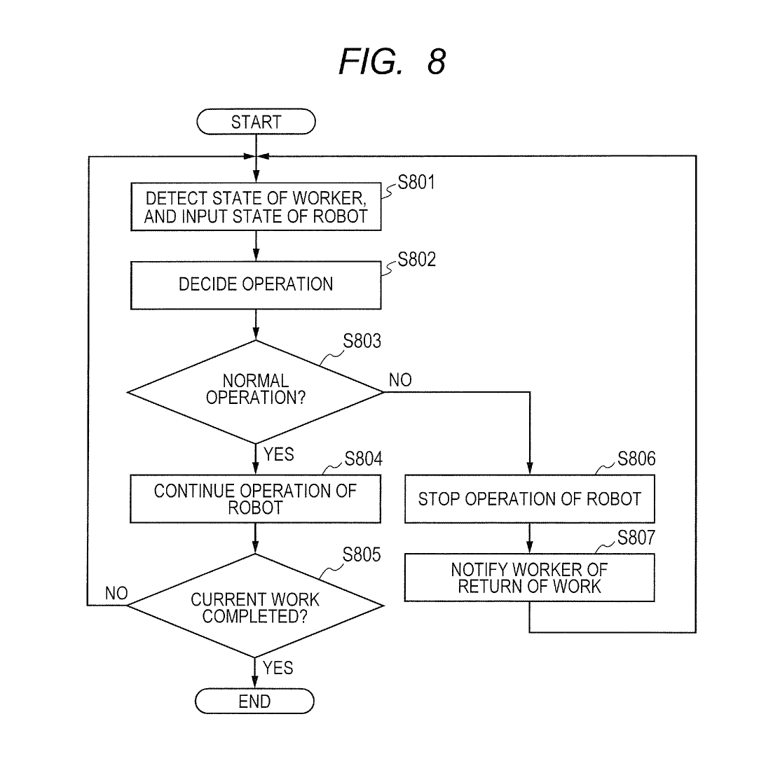

Next, the controlling procedure of the robot controlling apparatus 101 according to the present embodiment will be described with reference to the flow chart illustrated in FIG. 8.

In S801, the detecting unit 104 detects the state of the worker 203 based on the information input from the sensor 102, and outputs the detected state to the deciding unit 106. Moreover, the detecting unit obtains the information of the state of the robot 103 from the robot 103, and outputs the obtained information to the deciding unit 106.

In S802, the deciding unit 106 inputs the information of the worker from the detecting unit 104, inputs the information of the state of the robot from the robot 103, and inputs the information of the model from the learning information holding unit 105. Then, the deciding unit calculates the probability from the input information, compares the calculated probability with the threshold, and performs the operation deciding process based on the comparison result.

In S803, it is decided whether or not the probability calculated by the deciding unit 106 is equal to or higher than the threshold. If the probability calculated by the deciding unit 106 is equal to or hi her than the threshold, the process is advanced to S804. On the other hand, if the probability calculated by the deciding unit 106 is equal to or lower than the threshold, the process is advanced to S806.

In S804, it is decided that the operations of the robot 103 and the worker 203 are normal because the probability calculated by the deciding unit 106 is equal to r higher than the threshold, and the controlling unit 107 controls the operation of the robot 103 so as to continue the operation of the robot 103.

In S805, it is decided whether or not the current work is completed. Then, if the current work is not completed, the process is returned to S801. On the other hand, if the current work is completed, the process is ended.

In S806, it is decided that there is the possibility that the worker 203 is harmed, because the probability calculated by the deciding unit 106 is equal to or lower than the threshold, and the controlling unit 107 controls the operation of the robot so as to stop or decelerate the operation of the robot 103.

In S807, the deciding unit 106 holds the state at the time of stop or deceleration, and notifies the worker of the return of the work by means of a voice, a display or the like. After notifying the worker of the return of the work, the process is returned to S801 to again decide the operation of the robot based on the state of the worker output from the detecting unit 104, the state of the robot 103, and the learning information output from the learning information holding unit 105. Then, if the result of the operation deciding process indicates a normal operation, the robot controlling apparatus causes the worker to again start the work.

According to the constitution as described above, in case of performing the work in the space where the robot and the worker coexist, the learning information obtained by previously learning the time-series states of the robot and the worker currently performing the work is used. Then, if the probability that the time-series states of the worker and the robot currently performing the work are the time-series states of the worker and the robot at the time of learning is high, the robot is controlled so as to continue the operation.

If the probability that the time-series states of the worker and the robot currently performing the work are the time-series states of the worker and the robot at the time of learning is low, the robot is controlled so as to top or decelerate the operation. Moreover, after controlling the robot to stop or decelerate the operation, the return of the work is notified to the worker, so that the worker again starts the work. By the above control, it is possible for the robot controlling apparatus to improve the rate of operation of the robot, and it is thus possible to improve productivity while securing safety even in case of performing the work in the space where the worker and the robot coexist.

### Third Embodiment

As well as the first embodiment, the robot controlling apparatus according to the third embodiment uses, in case of performing the work in the space where the robot and the worker coexist, the learning information obtained by previously learning the time-series states of the work of the robot and the worker. Then, if a probability that the time-series states of the worker and the robot currently performing the work are the time-series states of the worker and the robot at the time of learning is high, the robot is controlled to continue the operation (work). On the other hand, if the probability that the time-series states of the worker and the robot currently performing the work are the time-series states of the worker and the robot at the time of learning is low, the robot is controlled to stop or decelerate the operation.

Besides, in the third embodiment, the robot controlling apparatus improves accuracy of the learning information by updating, while the work is being performed, the learning information with use of the states of the worker and the robot currently performing the work. By such control, the robot controlling apparatus improves a rate of operation of the robot, and thus improves productivity while securing safety even in case of performing the work in the space where the robot and the worker coexist.

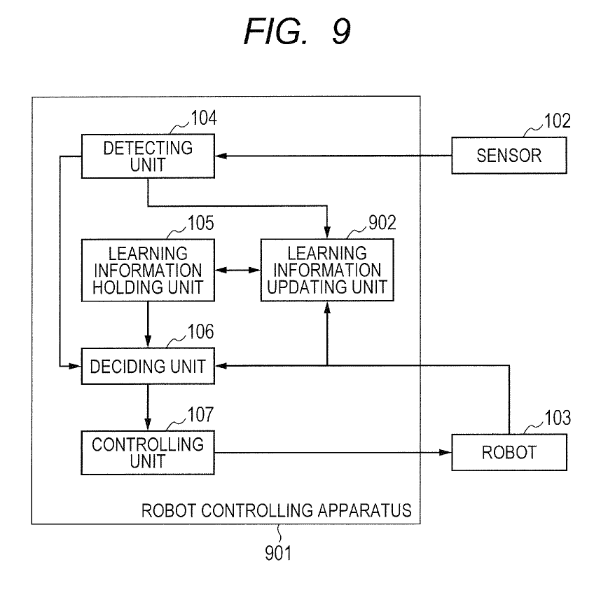

The constitution of the robot controlling apparatus according to the third embodiment will be described with reference to FIG. 9. As compared with the block constitution of the robot controlling apparatus 101 of FIG. 1 described in the first embodiment, a robot controlling apparatus 901 according to the third embodiment additionally comprises a learning information updating unit 902. The constitutions other than the learning information updating unit 902 are the same as those in the first embodiment.

The learning information updating unit 902 added to the robot controlling apparatus in the third embodiment will be described.

The learning information updating unit 902 updates the parameter of the model of the learning information holding unit 105, based on the time-series state of the robot 103 output from the robot 103 and the time-series state of the worker 203 output from the detecting unit 104. More specifically, sample information to be used for estimating the parameter is added, and then the parameter is again calculated. As a result, since the sample information increases, estimation accuracy of the parameter improves.

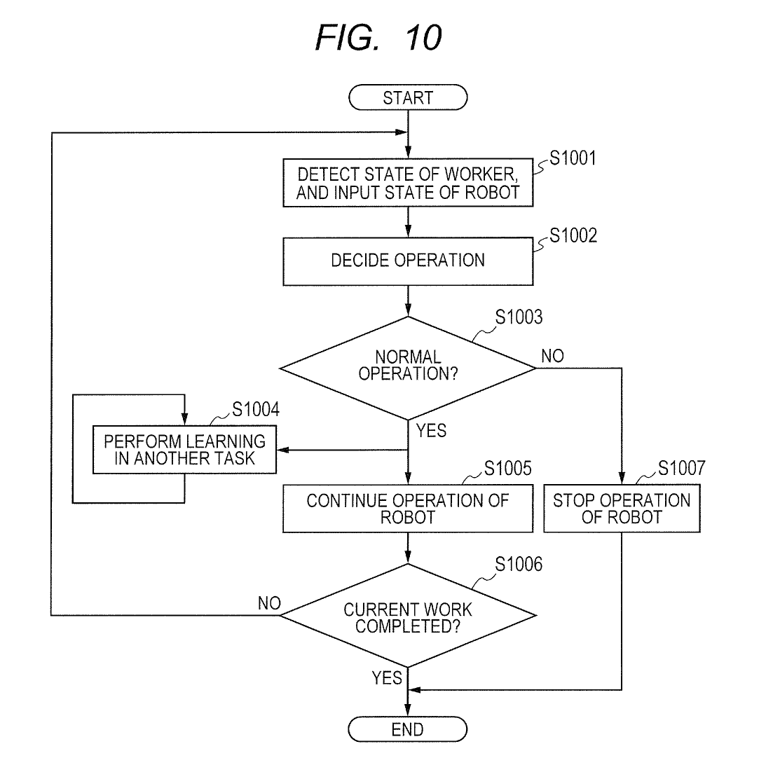

Next, the controlling procedure of the robot controlling apparatus 901 according to the present embodiment illustrated in FIG. 9 will be described with reference to the flow chart illustrated in FIG. 10.

In the detecting unit 104 detects the state of the worker 203 based on the information input from the sensor 102, and outputs the detected state to the deciding unit 106. Moreover, the detecting unit obtains the information of the state of the robot 103 from the robot 103, and outputs the obtained information to the deciding unit 106.

In S1002, the deciding unit 106 inputs the information of the worker 203 from the detecting unit 104, inputs the information of the state of the robot 103 from the robot 103, and inputs the information of the model from the learning information holding unit 105. Then, the deciding unit calculates the probability from the input information, compares the calculated probability with the threshold, and performs the decision based on the comparison result.

In S1003, it is decided whether or not the probability calculated by the deciding unit 106 is equal to or higher than the threshold. If the probability calculated by the deciding unit 106 is equal to or lower than the threshold, the process is advanced to S1007. On the other hand, if the probability calculated by the deciding unit 106 is equal to or higher than the threshold, the process is advanced to S1005. Besides, in S1004, the learning information updating unit 902 adds, in another task, the information of the state of the worker 203 and the information of the state of the robot 103 from the detecting unit 104, and inputs the information of the model from the learning information holding unit 105. Then, the learning information updating unit updates the parameter, and outputs the updated parameter to the learning information holding unit 105.

In S1005, it is decided that the operations of the robot 103 and the worker 203 are normal because the probability calculated by the deciding unit 106 is equal to or higher than the threshold, and the controlling unit 107 controls the robot 103 so as to continue the operation.

In S1006, it is decided whether or not the current work is completed. Then, if the current work is not completed, the process is returned to S1001. On the other hand, if the current work is completed, the process is ended.

In S1007, it is decided that there is a possibility that the worker is harmed by the operation of the robot because the probability calculated by the deciding unit 106 is equal to or Lower than the threshold, an the controlling unit 107 controls the robot 103 so as to stop or decelerate the operation of the robot 103.

According to the constitution as described above, in the case where the robot and the worker perform the work in the space where the robot and the worker coexist, the learning information obtained by previously learning the time-series states of the work of the robot and the worker is used. Then, if the probability that the time-series states of the worker and the robot currently performing the work are the time-series states of the worker and the robot at the time of learning is high, the robot is controlled to continue the operation. On the other hand, if the probability that the time-series states of the worker and the robot currently performing the work are the time-series states of the worker and the robot at the time of learning is low, the robot is controlled to stop or decelerate the operation.

In addition, according to the third embodiment, the robot controlling apparatus improves accuracy of the learning information by updating, while the work is being performed, the learning information with use of the states of the worker and the robot currently performing the work.

By doing so, it is possible to improve the rate of operation of the robot, and it is thus possible to improve productivity while securing safety even in case of performing the work in the space where the robot and the worker coexist.

### Fourth Embodiment

The robot controlling apparatus according to the fourth embodiment uses, in case of performing the work in the space where the robot and the worker coexist, the learning information obtained by previously learning the time-series states of the work of the robot and the worker. Then, if a probability that the time-series states of the worker and the robot currently performing the work are the time-series states of the worker and the robot at the time of learning is high, the robot is controlled to continue the operation (work).

On the other hand, if the probability that the time-series states of the worker and the robot currently performing the work are the learned time-series states of the worker and the robot is low, it is recognized whether or not the worker pays attention to (or watches) the operation of the robot. Then, if the worker pays attention to the operation of the robot, the robot is controlled to continue the operation. In the case where the probability that the time-series states of the worker and the robot currently performing the work are the learned time-series states of the worker and the robot is low, if the worker does not pay attention to the operation of the robot, the robot is controlled to stop or decelerate the operation.

By doing so, even if the worker performs an operation not learned, it is possible to operate the robot safely. As a result, the robot controlling apparatus improves a rate of operation of the robot, and thus improves productivity while securing safety even in case of performing the work in the space where the robot and the worker coexist.

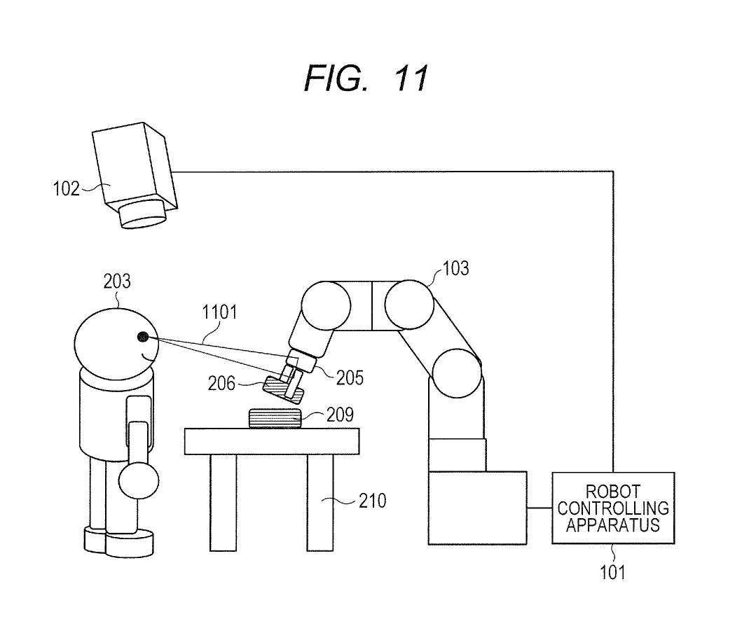

In the fourth embodiment, the constitutions other than the detecting unit 104 and the deciding unit 106 are the same as those of the robot controlling apparatus described in the first embodiment. Therefore, the detecting unit 104 and the deciding unit 106 according to the fourth embodiment will be described with reference to FIGS. 1 and 11.

The detecting unit 104 detects the state of the worker 203 from the information input from the sensor 102. Particularly, the detecting unit detects, in the state of the worker 203, the attention point of the worker 203 (i.e., the point to which the worker pays attention). Here, various methods of detecting the attention point have been proposed. For example, the method described in Japanese Patent Application Laid-Open No. H6-59804 may be used

FIG. 11 shows the state that the worker 203 pays attention to the hand 205 at the position extended along an eye (line of sighting) 1101 of the worker.

In the fourth embodiment, when the worker 203 pays attention to the hand 205, the robot 103 is controlled to continue the operation thereof even in the case where the probability that the time-series state of the robot 103 currently performing the work is the learned time-series state of the robot is low. Incidentally, in the fourth embodiment, the target for which the attention is decided is the hand 205. However, the part other than the hand 205 may be used as the target if the relevant part represents the operation of the robot 103.

The deciding unit 106 decides the operation of the robot 103, based on the time-series state of the robot 103 output from the robot 103, the time-series state of the worker 203 output from the detecting unit 104, and the model input from the learning information holding unit 105.

The deciding unit 106 compares the probability obtained by the expression (1) described in the first. embodiment with a preset threshold. Then, if the probability obtained the expression (1) exceeds the preset threshold, a control signal for continuing the operation of the robot 103 is output to the controlling unit 107.

On the other hand, if the probability obtained by the expression (1) is lower than the preset threshold, a control signal for -topping or decelerating the operation of the robot 103 is output to the controlling unit 107 because there is a fear that the worker 203 is harmed by the operation of the robot. In addition, in the case where the probability obtained by the expression (1) is lower then the preset threshold, when the worker 203 pays attention to the operation of the robot 103, the deciding unit 106 of the fourth embodiment outputs the control signal for continuing the operation of the robot 103 to the controlling unit 107.

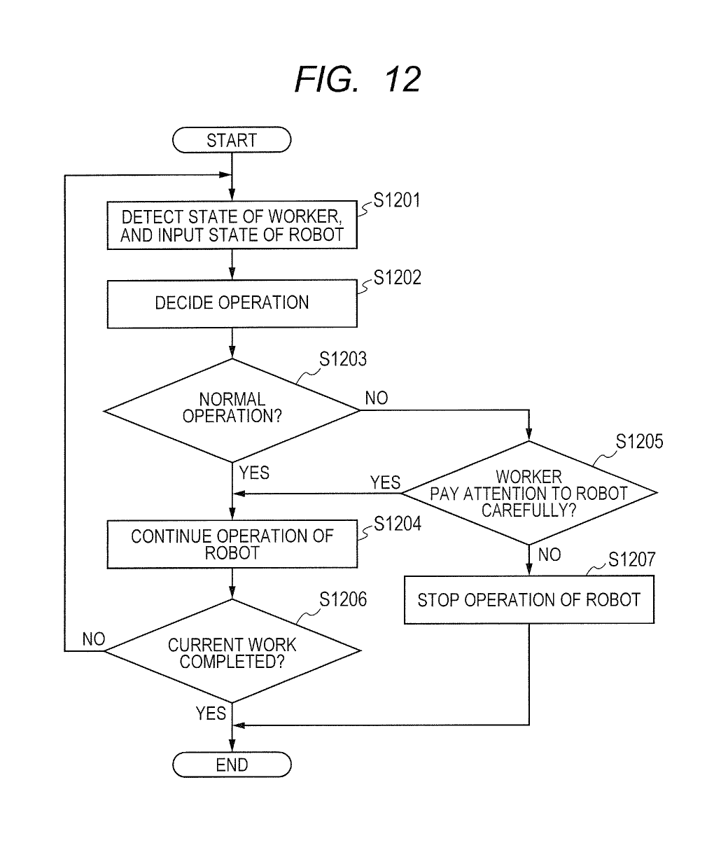

Next, controlling procedure of robot controlling apparatus 101 according to the present embodiment will be described with reference to the flow chart illustrated in FIG. 12.

In S1201, the detecting unit 104 outputs the state of the worker 203 to the deciding unit 106 based on the information input from the sensor 102. Moreover, the detecting unit obtains the information of the state of the robot 103 from the robot 103, and outputs the obtained information to the deciding unit 106.

In S1202, the deciding unit 106 inputs the information of the worker 203 from the detecting unit 104, inputs the information of the state of the robot from the robot 103, and inputs the information of the model from the learning information holding unit 105. Then, the deciding unit calculates the probability from the input information, compares the calculated probability with the threshold, and performs the decision based on the comparison result. In S1203, it is decided whether or not the probability calculated by the deciding unit 106 is equal to or hi her than the threshold. If the probability calculated by the deciding unit 106 is equal to or higher than the threshold, the process is advanced to S1204. On the other hand, if the probability calculated by the deciding unit 106 is equal to or lower than the threshold, the process is advanced to S1205.

In S1204, the deciding unit 106 decides that the operations of the robot 103 and the worker 203 are normal because the probability calculated by the deciding unit 106 is equal to or higher than the threshold, and the controlling unit 107 controls the robot 103 to continue the operation.

In S1205, the deciding unit 106 decides whether or not the worker 203 pays attention to the robot 103. If the worker 203 pays attention to the robot 103, the process is advanced to S1204. On the other hand, if the worker 203 does not pay attention to the robot 103, the process is advanced to S1207.

In S1206, the controlling unit 107 decides whether or not the current work is completed. Then, if the current work is not completed, the process is returned to S1201. On the other hand, if the current work is completed, the process is ended.

In S1207, it is decided that there is the possibility that the worker is harmed because the worker does not pay attention to the robot, and the controlling unit 107 controls the robot to stop or decelerate the operation thereof.

According to the constitution as described above, in the case where the robot and the worker perform the work in the space where the robot and the worker coexist, the learning information obtained by previously learning the time-series states of the work of the robot and the worker is used. Then, if the probability that the time-series states of the worker and the robot currently performing the work are the time-series states of the worker and the robot at the time of learning is high, the robot is controlled to continue the operation.

If the probability that the time-series states of the worker and the robot currently performing the work are the learned time-series states of the worker and the robot is low, it is recognized whether or not the worker pays attention to the operation of the robot. Then, if the worker pays attention to the operation of the robot, the robot is controlled to continue the operation.

In the case where the probability that the time-series stases of the worker and the robot currently performing the work are the learned time-series states of the worker and the robot is low, if the worker does not pay attention to the operation of the robot, the robot is controlled to stop or decelerate the operation.

By doing so, even if the worker performs the operation not learned, it is possible to operate the robot safely. As a result, it is possible to improve the rate of operation of the robot, and it is thus possible to improve productivity while securing safety even in case of performing the work in the space where the robot and the worker coexist.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment (s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

According to the present invention, the robot is controlled based on the states of the robot and the worker performing the work and the learning information obtained by time-serially learning the states of the robot and the worker. Thus, since the robot and the worker can perform the work safely in the space where the robot and the worker coexist it is possible to improve productivity.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2015-041691, filed Mar. 3, 2015, which is hereby incorporated by reference herein in its entirety.

What is claimed is:

1. A robot controlling apparatus which controls a robot by detecting time-series states of a worker and the robot, comprising:
a detecting unit configured to detect a state of the worker;
a learning information holding unit configured to hold learning information obtained by learning the time-series states of the robot and the worker; and
a controlling unit configured to control an operation of the robot based on the state of the worker output from the detecting unit and the learning information output from the learning information holding unit.

2. The robot controlling apparatus according to claim 1, wherein
the controlling unit further comprises a deciding unit configured to obtain the time-series state of the worker from the detected state of the worker, and decide whether or not the obtained time-series state of the worker is similar to the time-series state of the worker included in the learning information, and
the controlling unit controls the operation of the robot based on a decision result of the deciding unit.

3. The robot controlling apparatus according to claim 2, wherein, in a case where it is decided by the deciding unit that the obtained time-series state of the worker is not similar to the time-series state of the worker included in the learning information, the controlling unit stops or decelerates the operation of the robot.

4. The robot controlling apparatus according t claim 3, further comprising a notifying unit configured to, in the case where it is decided by the deciding unit that the obtained time-series state of the worker is not similar to the time-series state of the worker included in the learning information, notify the worker of information for urging to restart work after the operation of the robot is stopped or decelerated.

5. The robot controlling apparatus according to claim 3, wherein
in the case where it is decided by the deciding unit that the obtained time-series state of the worker is not similar to the time-series state of the worker included in the learning information, the controlling unit decides whether or not the worker pays attention to the robot,
in a case where it is decided that the worker pays attention to the robot, the controlling unit continues the current operation of the robot, and
in a case where it is decided that the worker does not pay attention to the robot, the controlling unit stops or decelerates the operation of the robot.

6. The robot controlling apparatus according to claim 2, wherein, in a case where it is decided by the deciding unit that the obtained time-series state of the worker is similar to the time-series state of the worker included in the learning information, the controlling unit continues the operation of the robot.

7. The robot controlling apparatus according to claim 1, wherein the state of the worker includes at least either a position and orientation of a predetermined part of the worker and a position and orientation of an object grasped by the worker.

8. The robot controlling apparatus according to claim 2, wherein the deciding unit further decides the operation of the robot based on a state of the robot.

9. The robot controlling apparatus according claim 8, wherein the state of the robot corresponds to position information of a hand or a joint of the robot.

10. The robot controlling apparatus according to claim 1, further comprising a learning information updating unit configured to update the learning information based on the state of the worker output from the detecting unit and the learning information output from learning information holding unit, and output the updated learning information to the learning information holding unit.

11. A robot controlling method which controls a robot by detecting time-series states of a worker and the robot, comprising:
detecting a state of the worker;
holding learning information obtained by learning the time-series states of the robot and the worker; and
controlling an operation of the robot based on the detected state of the worker and the held learning information.

12. A non-transitory computer-readable storage medium which stores a program for causing a computer to perform a robot controlling method of controlling a robot by detecting time-series states of a worker and the robot, the controlling method comprising:
detecting a state of the worker;
holding learning information obtained by learning the time-series states of the robot and the worker; and
controlling an operation of the robot based on the detected state of the worker and the held learning information.
